(19) United States
(12) Patent Application Publication
(10) Pub. No.: US 2024/0404388 A1
(43) Pub. Date: Dec. 5, 2024

(54) RESIDENCE MONITOR SYSTEM

(71) Applicant: Trey Welstad, Minot, ND (US)

(72) Inventor: Trey Welstad, Minot, ND (US)

(21) Appl. No.: 18/329,555

(22) Filed: Jun. 5, 2023

(51) Int. Cl. G08B 21/18; G08B 21/20

(52) U.S. Cl. CPC G08B 21/182; G08B 21/185; G08B 21/20

(57) ABSTRACT

A residence monitor system includes a sensor; a controller in communication with the sensor; a Wi-Fi module in communication with the controller; and a power cable to provide power to the sensor, the controller, and the Wi-Fi module, the controller operable to transmit an alert via the Wi-Fi module in response to the sensor detecting a predetermined event.

### CROSS REFERENCE TO RELATED APPLICATION[S]

None

### BACKGROUND

The present disclosure relates to a residence monitor system that is operable to remotely alert a user to various residence issues.

Water leaks, condensation, humidity, freezing temps, frozen pipes, and flooding may cause serious indoor damage to a residence. Existing systems for sensing such issues within a residence can be difficult to use, costly, cumbersome, and inefficient.

### SUMMARY

A residence monitor system according to one disclosed non-limiting embodiment of the present disclosure includes a sensor; a controller in communication with the sensor; a Wi-Fi module in communication with the controller; and a power cable to provide power to the sensor, the controller, and the Wi-Fi module, the controller operable to transmit an alert via the Wi-Fi module in response to the sensor detecting a predetermined event.

A further embodiment of any of the foregoing embodiments of the present disclosure includes that the predetermined event comprises detection of water.

A further embodiment of any of the foregoing embodiments of the present disclosure includes that the predetermined event comprises detection of a temperature.

A further embodiment of any of the foregoing embodiments of the present disclosure includes that the predetermined event comprises detection of a humidity.

A further embodiment of any of the foregoing embodiments of the present disclosure includes that the predetermined event comprises detection of a loss of power from the power cable.

A further embodiment of any of the foregoing embodiments of the present disclosure includes a server in communication with the controller via the Wi-Fi module.

A further embodiment of any of the foregoing embodiments of the present disclosure includes that the alert is transmitted via the Wi-Fi module to the server in response to the sensor detecting a predetermined event.

A further embodiment of any of the foregoing embodiments of the present disclosure includes that the controller is operable to communicate with the server at a predetermined time period.

A further embodiment of any of the foregoing embodiments of the present disclosure includes a flex PCB (ribbon) cable between the sensor and the controller.

A further embodiment of any of the foregoing embodiments of the present disclosure includes that the server is remotely accessible via a client-facing website.

A further embodiment of any of the foregoing embodiments of the present disclosure includes a housing that contains the controller and the Wi-Fi module.

A further embodiment of any of the foregoing embodiments of the present disclosure includes a domed-grid circular cutout within the housing that retains a piezo buzzer.

A further embodiment of any of the foregoing embodiments of the present disclosure includes a molded button supported upon two static hinges within the housing.

A method of remotely monitoring a residence with a remote monitor plugged into a power source, the remote monitor comprising a sensor adjacent to an area where moisture may collect according to one disclosed non-limiting embodiment of the present disclosure includes receiving a communication from the remote monitor at a server remote from the remote monitor in response to the sensor having sensed a predetermined event and transmitting an alert from the server to a client-facing website.

A further embodiment of any of the foregoing embodiments of the present disclosure includes that the predetermined event comprises detection of water.

A further embodiment of any of the foregoing embodiments of the present disclosure includes that the predetermined event comprises detection of a temperature.

A further embodiment of any of the foregoing embodiments of the present disclosure includes that the predetermined event comprises detection of a humidity.

A further embodiment of any of the foregoing embodiments of the present disclosure includes that the predetermined event comprises detection of a lack of communication for a predetermined time period.

A further embodiment of any of the foregoing embodiments of the present disclosure includes that transmitting the alert from the server to the client-facing website comprises transmitting a power outage alert.

A further embodiment of any of the foregoing embodiments of the present disclosure includes that receiving the communication from the remote monitor comprises receiving the communication over the Internet via a Wi-Fi module in the remote monitor.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a residence monitor system according to one disclosed non-limiting embodiment.

FIG. 2A is a perspective view of a remote monitor according to one disclosed non-limiting embodiment.

FIG. 2B is a perspective view of a remote monitor according to another disclosed non-limiting embodiment.

FIG. 3A is a schematic view of the remote monitor.

FIG. 3B-3I are views of a housing for the remote monitor.

FIG. 4 is a schematic block diagram of logic that is representative of a method to transmit an alert in response to the remote monitor detecting a predetermined event.

FIG. 5 is an example page of a client-facing website of the residence monitor system.

FIG. 6 is an example page of a client-facing website of the residence monitor system.

FIG. 7 is an example page of a client-facing website of the residence monitor system.

### DETAILED DESCRIPTION

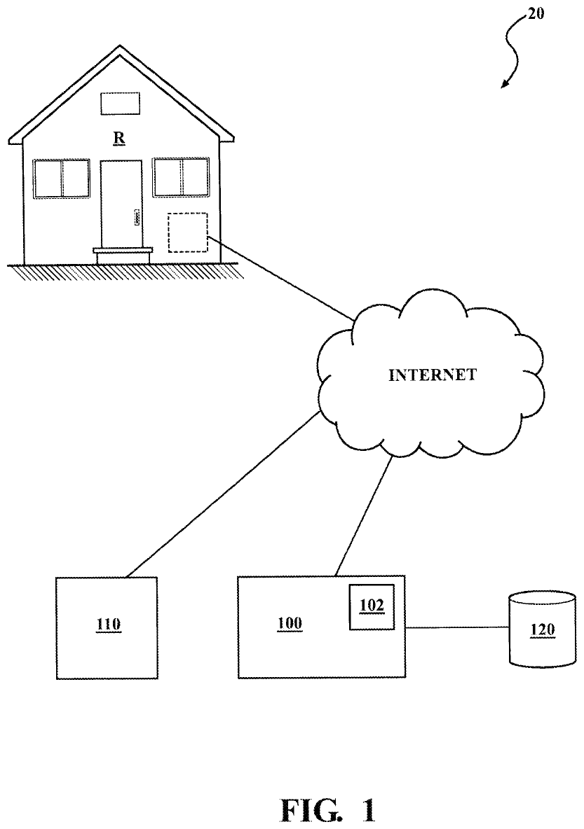

FIG. 1 schematically illustrates a residence monitor system 20 that is operable to remotely alert a user to various residence issues such as, for example, water leaks, temperature, humidity, and power outages. The system 20 generally includes a remote monitor 30 for a residence R, a server 100 located at a location remote from the residence R, a client-facing website 110 and a database 120.

The server 100 runs an alert application 102 that communicates with the remote monitor 30 and the client-facing website 110 to provide alerts to a user via the client-facing website 110 regarding potential residence issues as further described below. The server 100 may include computing device hardware (e.g., processing devices, etc.) and/or software that provide data and computation functionality services to programs, models, and devices via a request-response methodology. Server 100 may comprise memory storing computer executable programs, such as the alert application 102, executed by one or more processors to implement the functionality described herein. The server 100 may also include communications interfaces with external components. The term “server” conveys its customary meaning that provides service and/or data connection to, for example, the client-facing website 110.

The server 100 may further communicate with a user in response to data provided to the client-facing website 110 by the user so as to provide the alerts via other desired direct methods of communications, including, for example, an SMS, MMS, cellular, GSM, CDMA, Wi-Fi, Wi-Max, wireless transmission, the Internet, LAN, WAN, email, mobile application (app), and combinations thereof.

The client-facing website 110 may be a website published on a web server and available publicly via the internet. Alternatively, the client-facing website may be a mobile application (app). Alternatively, or in addition, the client-facing website 110 may be configured to include private access to the particular clients, via, for example, a password protected section. The user can change settings of the remote monitor 30 on the client-facing website 110, such that the server 100 sends those settings updates to the remote monitor 30. The remote monitor 30 checks for any available updates every time a reading is uploaded.

In one embodiment, the user need not utilize an app and may communicate with the server 100 and thus the remote monitor 30 via the client-facing website 110.

The database 120 may be an organized collection of data that includes database management systems that allow for manipulation of data through update and retrieval for use by the server 100. The database 120 may store current and historical data associated with one or more remote monitors 30.

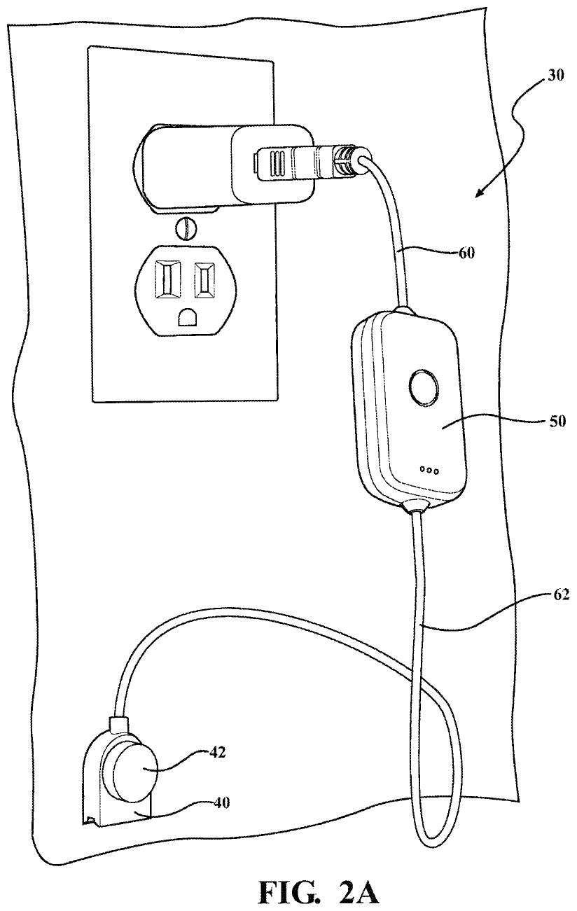

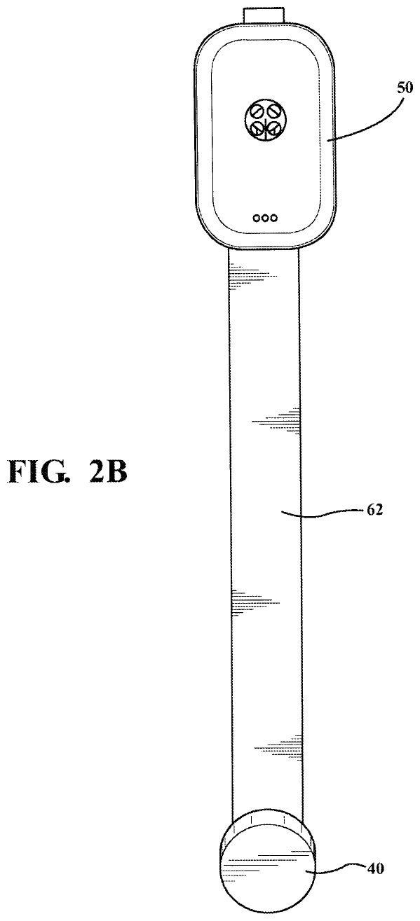

With reference to FIG. 2A, the remote monitor 30 may generally include a sensor 40, a controller 50, and a power cable 60. The remote monitor 30, in this embodiment is a single device that may be plugged into a power source such as a conventional power outlet such that the sensor 40 is positioned in an area where moisture may collect such as near, a sump pump, drains, sinks, water heater, washing machine, dishwasher, freezer, refrigerator, leaky windows or doors, air conditioner, condensate pump, etc.

The sensor 40 may include a moisture sensor, temperature sensor, humidity sensor, and/or combinations thereof. The sensor 40 may also include an attachment 42 such as a magnet, double sided tape, etc., to facilitate placement. The sensor 40 in one embodiment is in communication with the controller 50 via a cable 62 which may be, for example, five feet long. In one embodiment, the cables 60, 62 may be soldered to the controller 50. Alternatively, the cables 60, 62 may plug in to the controller 50 via, for example, a USB-C connector, a 3.5 mm headphone jack connector or other such connector. This decreases the number of solder points on the PCB and reduces assembly time.

In another embodiment, the cable 60 to the sensor 40 may be a flex PCB (ribbon) cable 62 (FIG. 2B) to facilitate mounting of the sensor 40 within a closed container such as a freezer, refrigerator, etc. That is, the flex PCB (ribbon) cable 62 (FIG. 2B) will not affect the seal of a freezer, refrigerator, etc. such that the sensor 40 can remain therein. The flex PCB (ribbon) cable 62, may be, for example, less than one inch wide and only a fraction of a millimeter in thickness.

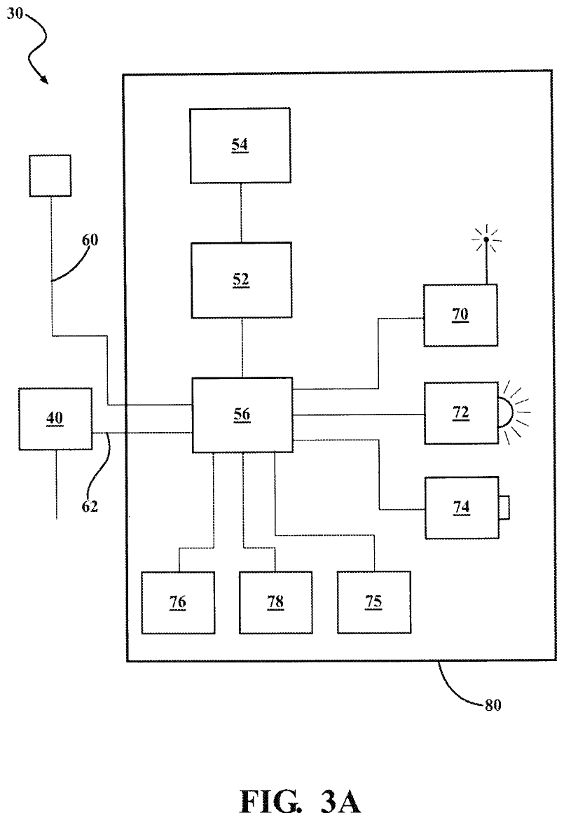

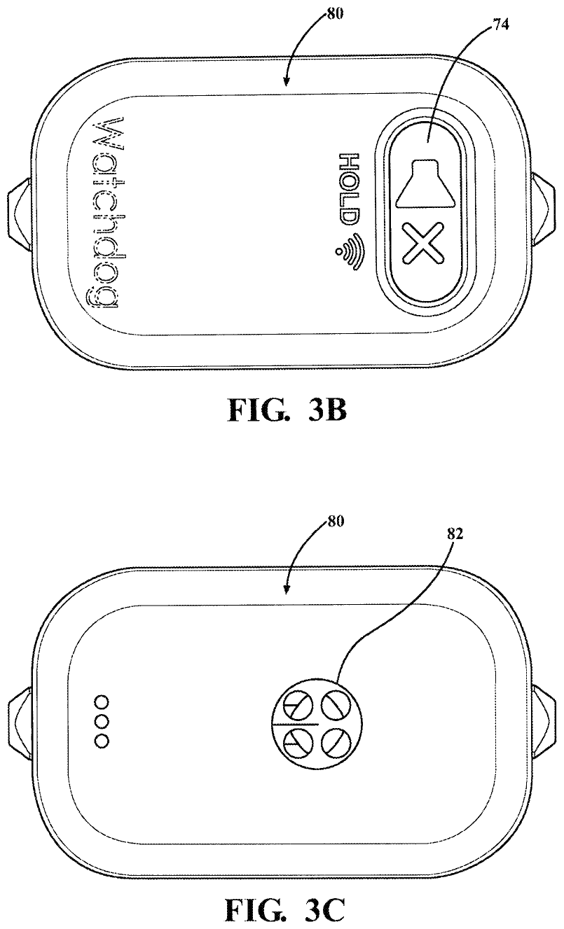

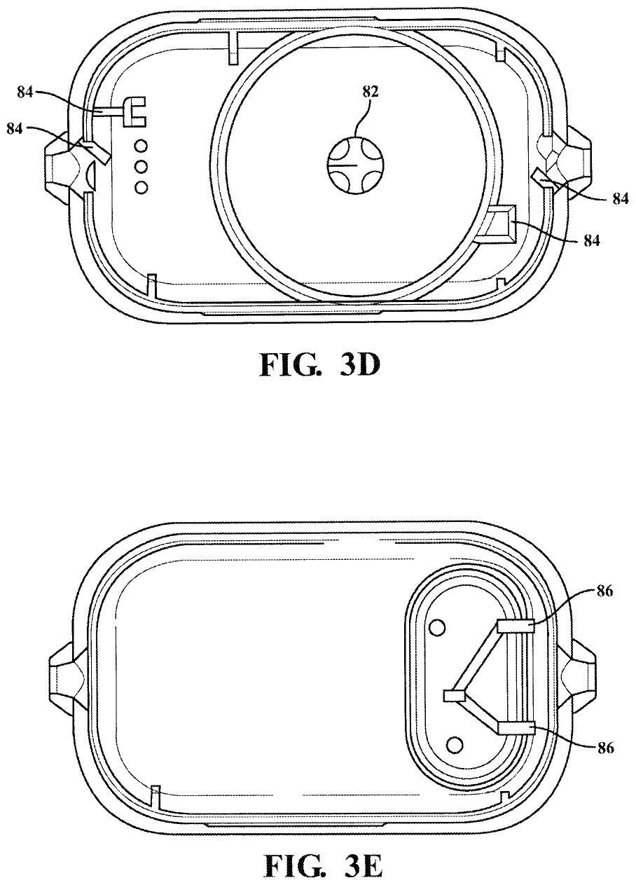

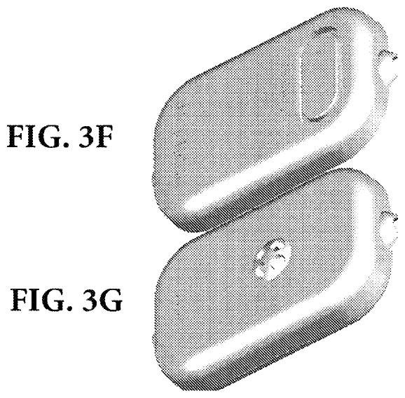

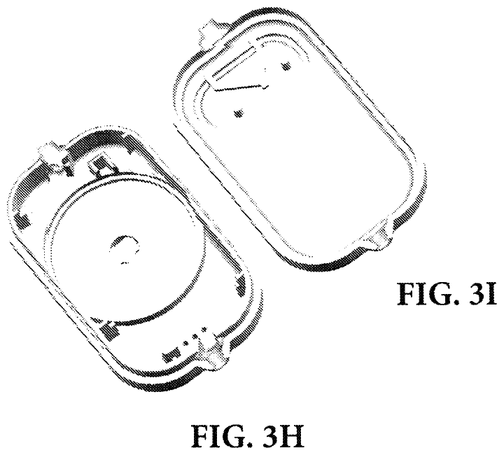

With reference to FIG. 3A, the controller 50 may include hardware, firmware, and/or software structures that are configured to perform the functions disclosed herein. The controller 50 may include at least one processor 52, e.g., a controller, microprocessor, microcontroller, digital signal processor, etc., a memory 54, and an input/output (I/O) subsystem 56. The processor 52 and the I/O subsystem 56 may be communicatively coupled to the memory 54. The memory 54 may be embodied as any type of suitable persistent storage devices, e.g., ROM, flash memory, memory chips, cards, etc. The I/O subsystem 56 may be communicatively coupled to several hardware, firmware, and/or software structures, including the sensor 40, the power cable 60, a wi-fi module 70, a display 72 such as a LED, a user interface (UI) 74 such as a button, and a buzzer 75 that may also be integral to the PCB. Other additional sensors such as a temperature sensor 76 and a humidity sensor 78 may alternatively or additionally be provided either with the sensor 40 or with the controller 50.

In one embodiment, the controller 50, the Wi-Fi module 70, the display 72, the user interface (UI) 74 and the buzzer 75 may be integrated on a single printed circuit board (PCB) which is contained in a housing 80 from which the sensor cable 62 to the sensor 40 and the power cable 60 extend. The power cable 60 may terminate with various connectors, such as, for example, a plug, a USB connector to plug into an adapter, etc.

With reference to FIG. 3B-3I, the housing 80 may include a circular cutout with domed-grid 82 that allows the piezo buzzer 75 to be inserted. The circular cutout with domed-grid 82 avoids the need for a separate dome cover to amply the sound and protect the piezo disc. The housing 80 and the circular cutout with domed-grid 82 may be readily manufactured via injection molding with a standard mold (no undercuts in the design) to allow the buzzer 75 to perform near maximum resonance yet offer protection of the domed-grid design.

The housing 80 may also include cable locks 84 which retain the cables 60, 62 to provide a secure hold which need only be pressed into the lock 84 to secure the cables 60, 62 without tools, glue, heat, or molded strain relief. That is, the housing (FIG. 3B-3I) may be snapped together and the locks 84 retain the cables 60, 62.

The housing 80 may also include a molded in button as the user interface 74 that is manufacturable with a standard mold (no undercuts) as part of the housing 80, so there is no separate button part that needs to be inserted during assembly. The button uses two static hinges 86 (FIG. 3E) that need only slightly flex to allow movement of the button to actuate a switch on the controller 50 which may be a single integral PCB. An LED on the controller 50 (e.g., a PCB) illuminates and colors the space around the periphery of the button.

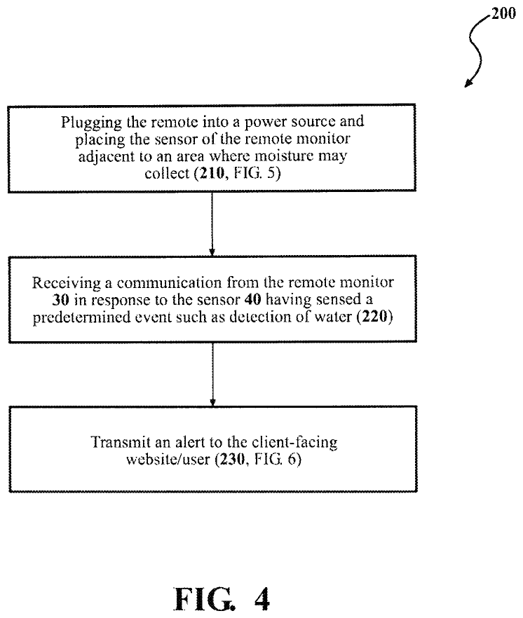

With reference to FIG. 4, the controller 60 executes logic representative of a method 200 to transmit an alert via the Wi-Fi module in response to the sensor 40 detecting a predetermined event. The functions of the method 200 are disclosed in terms of functional block diagrams, and it should be appreciated that these functions may be enacted in either dedicated hardware circuitry or programmed software routines capable of execution in a microprocessor-based electronics control embodiment of the controller 50.

The method 200 is initiated by plugging the remote monitor 30 into a power source and placing the sensor 40 of the remote monitor 30 adjacent to an area where moisture may collect (210).

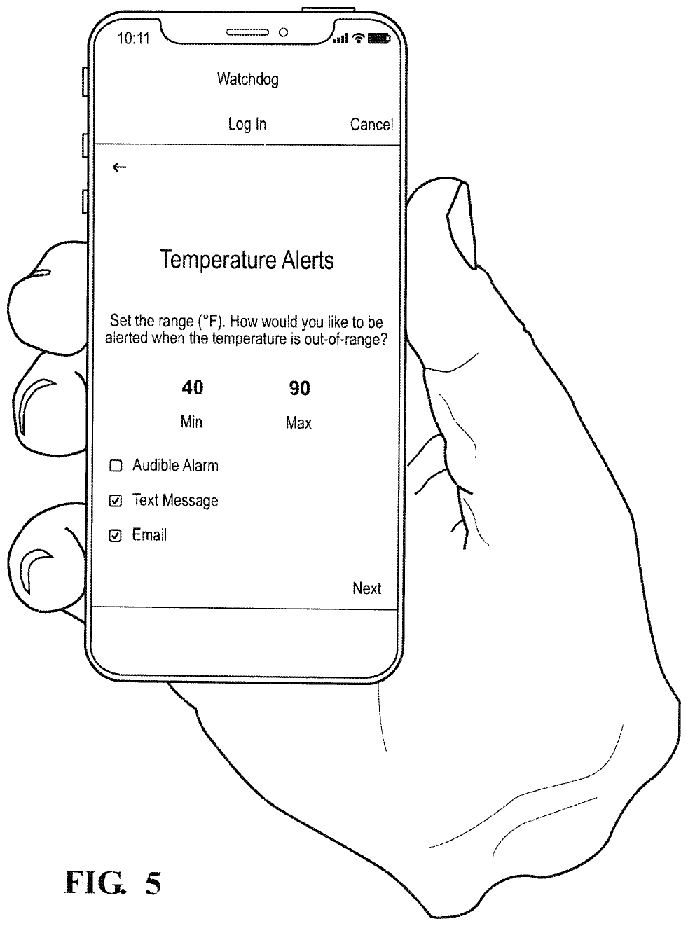

The remote monitor 30 is then connected to the Internet and the client-facing website 110 is accessed to set-up desired alerts (FIG. 5). The client-facing website 110 may alternatively or additionally utilize a captive portal. For example, predetermined alerts may set as a max/min temperature, humidity, etc. The type of alert may also be selected, for example, via audible alarm, text message, email, etc.

The remote monitor 30 can be setup using any device with Wi-Fi capability and a web browser without the need of an app. In one embodiment, the setup process is as follows: 1. User holds button on device until the light around the button turns blue; 2. This makes the device broadcast a Wi-Fi network; 3. User connects to the broadcasted network; 4. On many devices, the setup portal will pop up using a technology called captive portal. If the device does not have captive portal capability, the user can access the setup portal via their web browser by visiting a specified web address;5. The setup portal will guide the user to view and modify the device's settings. The first step in the setup portal is to connect the device to a Wi-Fi network with internet. The device will find and display all available networks. User selects an available network, enters password if required, and presses connect; 6. This screen lets the user know they are successfully connected to a Wi-Fi network. If the connection fails, a page with that information appears instead; 7. User enters an email address to receive email alerts and access device online; 8. User enters phone number to receive text message alerts; 9. Users can state the device location (e.g. Basement, Utility Room) so they know which specific device is detecting the problem; 10. Users choose how they want to be alerted to detected water problems; 11. Users choose how they want to be alerted to detected temperature problems. The acceptable range can be modified; 12. Users choose how they want to be alerted to detected humidity problems. The acceptable range can be modified; 13. Setup process is complete. User can click a button on-screen to close the captive portal window.

Once the remote monitor 30 is setup, the server 100 may receive a communication from the remote monitor 30 in response to the sensor 40 having sensed a predetermined event such as detection of water (220). The remote monitor 30 may communicate with the server 100 over the Internet via the Wi-Fi module 70 in the remote monitor. The remote monitor 30 may communicate with the server 100 on a regular basis such as every 1 minute, 5 minutes, 15 minutes, etc. to provide data such as temperature, humidity, etc. The 15 minutes period may be a default amount of time the residence monitor system 20 is unable to upload a reading before considered disconnected, thus a power outage is identified. Alternatively, or in addition, the remote monitor 30 may communicate with the server 100 in response to sensing of the predetermined event.

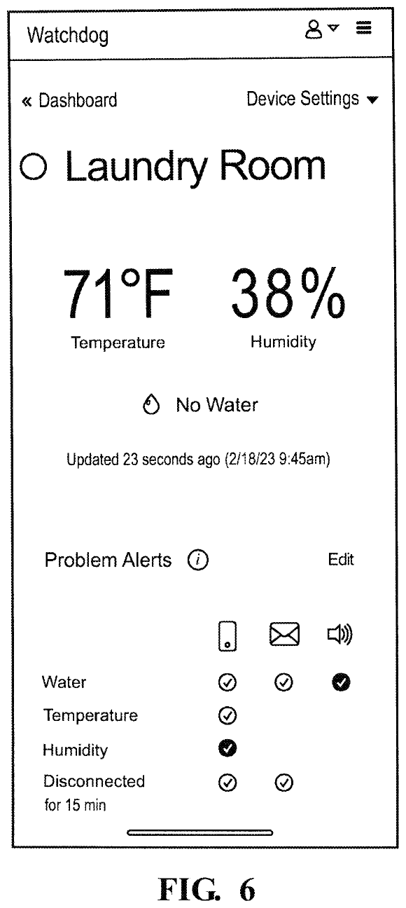

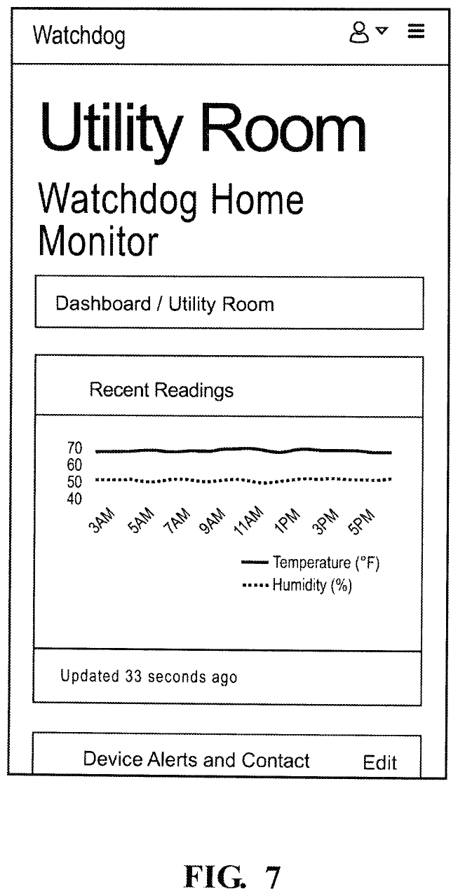

Next, the server 100 may transmit an alert to the client-facing website 110 (230). The alert may include data such as temperature, humidity, etc., over time (FIGS. 6 and 7). Alternatively, or in addition, the server 100 may transmit the alert as an email, text message, etc., in response to a time critical event such as flooding, loss of power, etc.

The residence monitor system 20 is advantageously operable to remotely alert a user to various residence issues such as, for example, water leaks, temperature, humidity, and power outages without the requirements of an app, network hub, or batteries.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A residence monitor system, comprising:
a sensor;
a controller in communication with the sensor;
a Wi-Fi module in communication with the controller; and
a power cable to provide power to the sensor, the controller, and the Wi-Fi module, the controller operable to transmit an alert via the Wi-Fi module in response to the sensor detecting a predetermined event.

2. The residence monitor system as recited in claim 1, wherein the predetermined event comprises detection of water.

3. The residence monitor system as recited in claim 1, wherein the predetermined event comprises detection of a temperature.

4. The residence monitor system as recited in claim 1, wherein the predetermined event comprises detection of a humidity.

5. The residence monitor system as recited in claim 1, wherein the predetermined event comprises detection of a loss of power from the power cable.

6. The residence monitor system as recited in claim 1, further comprising a server in communication with the controller via the Wi-Fi module.

7. The residence monitor system as recited in claim 6, wherein the alert is transmitted via the Wi-Fi module to the server in response to the sensor detecting a predetermined event.

8. The residence monitor system as recited in claim 6, wherein the controller is operable to communicate with the server at a predetermined time period.

9. The residence monitor system as recited in claim 1, further comprising a flex PCB (ribbon) cable between the sensor and the controller.

10. The residence monitor system as recited in claim 1, wherein the server is remotely accessible via a client-facing website to view information from the sensor over time.

11. The residence monitor system as recited in claim 1, further comprising a housing that contains the controller and the Wi-Fi module.

12. The residence monitor system as recited in claim 11, further comprising a circular cutout domed-grid within the housing that retains a piezo buzzer.

13. The residence monitor system as recited in claim 12, further comprising a molded button supported upon two static hinges within the housing.

14. A method of remotely monitoring a residence with a remote monitor plugged into a power source, the remote monitor comprising a sensor adjacent to an area where moisture may collect, the method comprising:
receiving a communication from the remote monitor at a server remote from the remote monitor in response to the sensor having sensed a predetermined event; and
transmitting an alert from the server to a client-facing website.

15. The method as recited in claim 14, wherein the predetermined event comprises detection of water.

16. The method as recited in claim 14, wherein the predetermined event comprises detection of a temperature.

17. The method as recited in claim 14, wherein the predetermined event comprises detection of a humidity.

18. The method as recited in claim 14, wherein the predetermined event comprises detection of a lack of communication for a predetermined time period.

19. The method as recited in claim 18, wherein transmitting the alert from the server to the client-facing website comprises transmitting a power outage alert.

20. The method as recited in claim 14, wherein receiving the communication from the remote monitor comprises receiving the communication over the Internet via a Wi-Fi module in the remote monitor.
